(19) United States
(12) Patent Application Publication
(10) Pub. No.: US 2020/0193530 A1
(43) Pub. Date: Jun. 18, 2020

(54) GEOLOCATING SOCIAL NETWORKING SYSTEM

(71) Applicant: Qian Christian Grosvenor, Diego Martin (TT)

(72) Inventor: Qian Christian Grosvenor, Diego Martin (TT)

(21) Appl. No.: 16/661,113

(22) Filed: Oct. 23, 2019

Related U.S. Application Data
(60) Provisional application No. 62/750,107, filed on Oct. 24, 2018.

(51) Int. Cl. G06Q 50/00; H04W 4/029; H04H 60/54; G01S 19/31

(52) U.S. Cl. CPC G06Q 50/01; G01S 19/31; H04H 60/54; H04W 4/029

(57) ABSTRACT

The geolocating social networking system disclosed herein may allow users to find people from their home country, city, town, school, college, or university from anywhere in the world who is also at their current location. In a foreign country one may not know anyone or may find it hard to fit in and meet people due to cultural and language barriers. The mobile application is meant for finding people from the user's identified point of origin, or any self-identified point of origin, who is located within an identified proximity of the user. The social networking system aims to connect people travelling from their point of origin with other people from the same point of origin, so that they may find a familiar face in an unfamiliar place. The system uses geolocating hardware on mobile devices in combination with user-inputs to match persons with one another.

### TECHNICAL FIELD OF THE INVENTION

The present invention relates in general to social networking software, and, more specifically, to a geolocating social networking system.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A social networking service (also social networking site or social media) is an online platform which people use to build social networks or social relations with other people who share similar personal or career interests, activities, backgrounds, or real-life connections. Social networking services vary in format and the number of features, and can incorporate a range of new information and communication tools, operating on desktops and on laptops, and on mobile devices such as tablet computers and smartphones.

Social networking sites allow users to share ideas, digital photos and videos, posts, and to inform others about online or real-world activities and events with people in their network. While in-person social networking has existed since the earliest development of society, the internet enables people to connect with others who live in different locations, ranging from across a city to across the world. Depending on the social media platform, members may be able to contact any other member. In other cases, members can contact anyone they have a connection to, and subsequently anyone that contact has a connection to, and so on. The success of social networking services can be seen in their dominance in society today, with Facebook having a massive 2.13 billion active monthly users and an average of 1.4 billion daily active users in 2017. LinkedIn, a career-oriented social-networking service, generally requires that a member personally know another member in real life before they contact them online. Some services require members to have a preexisting connection to contact other members.

The main types of social networking services contain category places (such as age or occupation or religion), means to connect with friends (usually with self-description pages), and a recommendation system linked to trust. One can categorize social-network services into three types: (1) socializing social network services used primarily for socializing with existing friends, (2) networking social network services used primarily for non-social interpersonal communication, and (3) social navigation social network services used primarily for helping users to find specific information or resources.

There is a need in the art for a geolocating social networking system that implements the advantages of current social networking services while allowing users travelling around the world to network with other users from their designated place of origin.

### BRIEF SUMMARY OF THE INVENTION

To minimize the limitations in the prior art, and to minimize other limitations that will be apparent upon reading and understanding the present specification, the present invention describes a geolocating social networking system.

It is an objective of the present invention to provide a geolocating social networking system that may be implemented on a computing device.

It is another objective of the present invention to provide a geolocating social networking system that may comprise a proprietary software.

It is another objective of the present invention to provide a geolocating social networking system that comprise a central database.

It is another objective of the present invention to provide a geolocating social networking system that comprise a user database.

It is another objective of the present invention to provide a geolocating social networking system that comprise a plurality of user types.

It is another objective of the present invention to provide a geolocating social networking system that comprise a plurality of user features.

It is another objective of the present invention to provide a geolocating social networking system that comprise a plurality of user origin settings.

It is another objective of the present invention to provide a geolocating social networking system that comprise a plurality of search parameters.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an overview of a geolocating social networking system, as contemplated by the present disclosure;

FIG. 2 schematically presents a computing system configured to carry out and actualize methods and tasks described herein, as contemplated by the present disclosure;

FIG. 3 illustrates drawings of a prototypical user interface of a geolocating social networking system, as contemplated by the present disclosure;

FIG. 4 illustrates drawings of a prototypical user interface of a geolocating social networking system, as contemplated by the present disclosure;

FIG. 5 illustrates drawings of a prototypical user interface of a geolocating social networking system, as contemplated by the present disclosure; and

FIG. 6 illustrates drawings of a prototypical user interface of a geolocating social networking system, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention relates in general to social networking software, and, more specifically, to a geolocating social networking system. As contemplated by the present disclosure, the system may comprise a proprietary software on a computing device and may use the geolocating hardware on the device to locate and match users with one another.

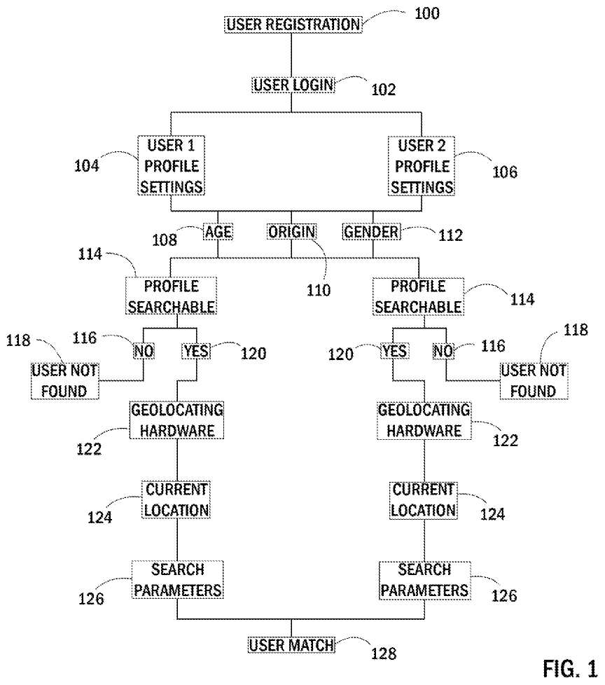

The illustration of FIG. 1 illustrates an overview of a geolocating social networking system. A user may begin using the system by downloading the proprietary software or accessing a webpage for the system and registering 100 an account with the system. The user may set up a login 102, which may comprise a username and password combination, or which may allow a user to login using the credentials they have on other social networking sites to which they are registered. Once a user has logged in the user may establish and select a plurality of profile settings that relate to their own profile. By way of example, a first user may select profile settings 104 that relate to their age 108, their point of origin 110, their gender 112, or any other appropriate characteristic. A second user may also select profile settings 106 related to such parameters, and, in this way, a database of user profiles with various set parameters may be established.

Once the user has selected their profile settings, the user may establish whether or not their profile is searchable 114. If a user sets their profile to not-searchable 116, the user's profile may be kept private by the system and they will not be found in a user search 118. If the user sets their profile to searchable 120, on the other hand, the system may then proceed to broadcast the user's location or make their profile available in search results. To achieve such a function the system may implement the geolocating hardware 122 on the user's computing device to determine the user's present location. Such geolocating hardware 122 may comprise, for example, the global-position satellite (GPS) hardware on a smart phone or mobile tablet, or may comprise the internet protocol (IP) address of an internet-connected device.

The system, having recognized that a user is searchable 120 and having identified the user's current location 124, may then either broadcast the user's location to other users within a pre-determined proximity to the user, or make the user's profile available in the search results of other user's whose search parameters 126 match the user's own. Having made such a user match 128, the system may then identify to each user in the match the profile of the other user.

In more detail, the search parameters 126 of a given user are primarily centered around the current location 124 of a given user and that user's identified point of origin 110. A user must set their origin 110, which may be a self-identified city, state, country, school, college, university, or any other appropriate origin 110, and the system will combine such origin 110 information with a user's current location 124 and search parameters 126 to create a list of results. By way of example, a user from Port of Spain, the capital city of Trinidad and Tobago, may be travelling to or currently located in New York City. In such an example the user may self-identify Port of Spain as their origin 110, and the system will implement the geolocating hardware 122 on the user's device to determine that the user's current location 124 is New York City. The user may then access the system to search for other users within their proximity who have also self-identified their origin 110 as Port of Spain, and the system will report to the user all profiles that are searchable 120 and fitting the selected parameters. As another example, a student user from New York University on vacation in the French Quarter of New Orleans, Louisiana, may self-identify New York University as their origin 110, and the system will set the French Quarter as the user's current location 124. The search parameters 126 may comprise further additional details, such as age 108, gender 112, culture, religion, language, school major, education level, profession, or any other appropriate parameters, but the minimum search parameters must include a point of origin 110 and a current location 124.

The system may further comprise features commonly implemented in social networking systems for convenience, portability, and ease of use. The system may, for example, be able to network with other social networking sites, such as Facebook or LinkedIn, to grab a user's demographic information and autopopulate their profile. The user may then review such entries and modify the parameters as appropriate before setting their profile. The user may also revise or change their selected parameters at any time after their initial registration. The system may also capture a user's images from the other social networking sites, if desired, so that the user may add a plurality of profile pictures to their profile. In the same vein, the system may post a user's information, if desired, to the other social networking sites.

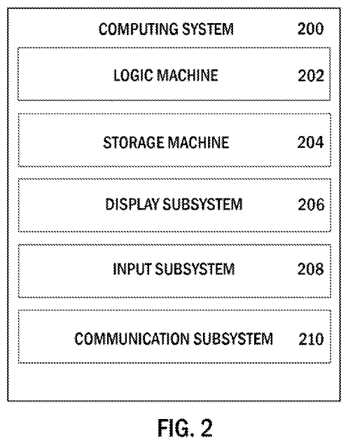

The illustration of FIG. 2 schematically presents a computing system that may represent an embodiment of the present invention. In some embodiments the method is executed on a computing system such as computing system 200. For example, storage machine 204 may hold instructions executable by logic machine 202 to provide the method to users.

Display subsystem 206 may display the various elements of the method to participants. For example, display subsystem 206, storage machine 204, and logic machine 202 may be integrated such that the method may be executed while being displayed on a display screen. The input subsystem 208 may receive user input from participants to indicate the various choices or user inputs described above.

The described method may be executed, provided, or implemented to a user on one or more computing devices via a computer-program product such as via an application programming interface (API). Computing system 200 may be any appropriate computing device such as a personal computer, tablet computing device, gaming device or console, mobile computing device, etc. Computing system 200 includes a logic machine 202 and a storage machine 204. Computing system 200 may include a display subsystem 206, input subsystem 208, and communication subsystem 210.

Logic machine 202 may execute machine-readable instructions via one or more physical devices. For example, the logic machine 202 may be configured to execute instructions to perform tasks for a computer program. The logic machine may include one or more processors to execute machine-readable instructions.

Storage machine 204 includes one or more physical devices configured to hold or store instructions executable by the logic machine to implement the method. When such methods and processes are implemented, the state of storage machine 204 may be changed to hold different data. For example, storage machine 204 may include memory devices such as various hard disk drives or CD or DVD devices.

Display subsystem 206 may visually present data stored on storage machine 204. For example, display subsystem 206 may visually present data to form a graphical user interface (GUI). Input subsystem 208 may be configured to connect and receive input from devices such as a mouse, keyboard, or gaming controller. Communication subsystem 210 may be configured to enable system 200 to communicate with other computing devices. Communication subsystem 210 may include wired and/or wireless communication devices to facilitate networked communication.

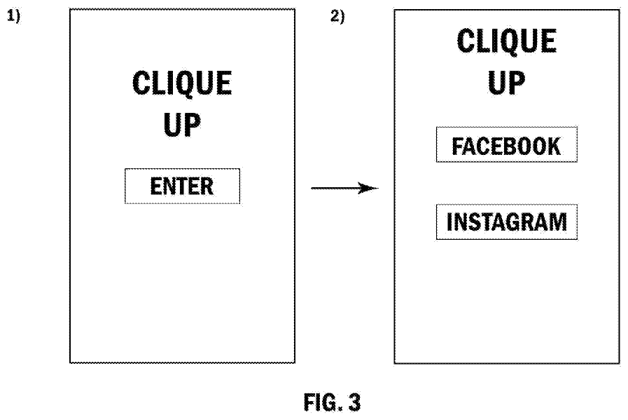

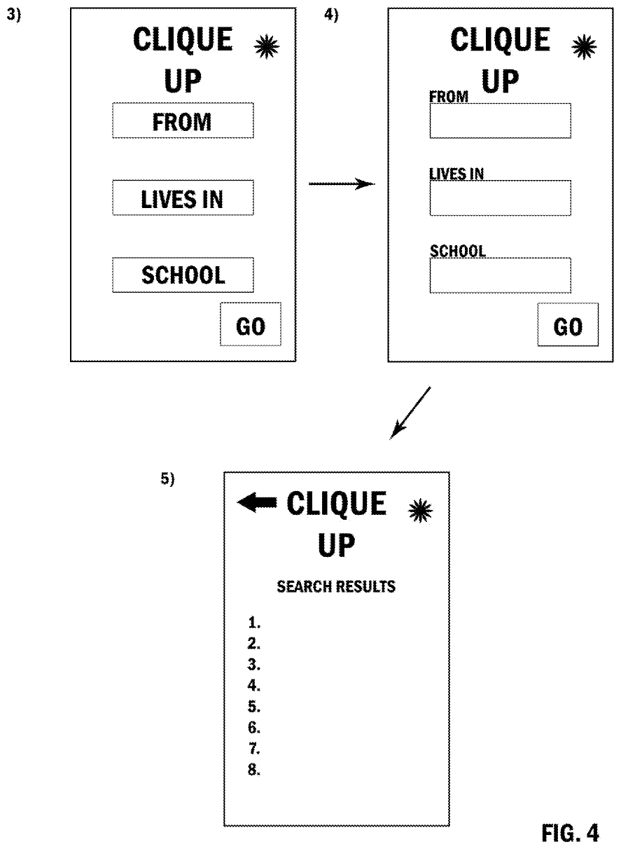

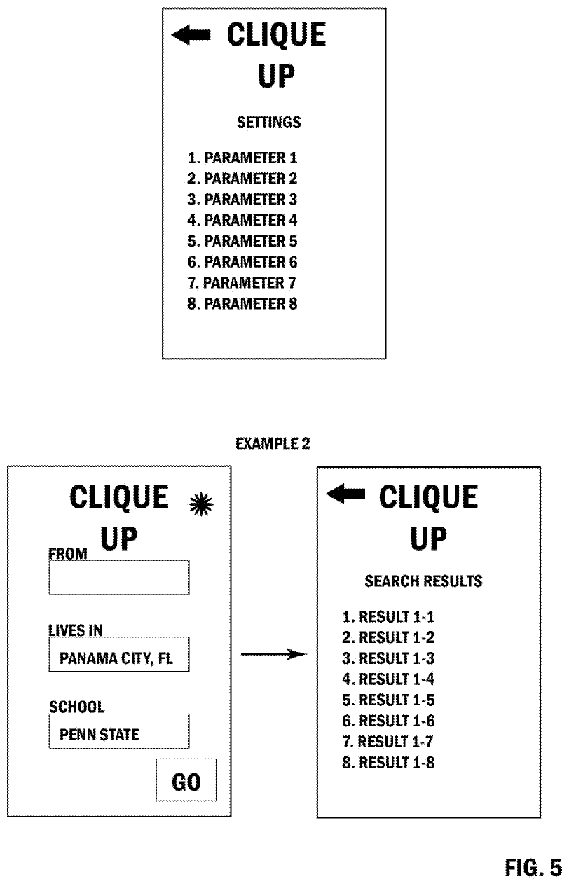

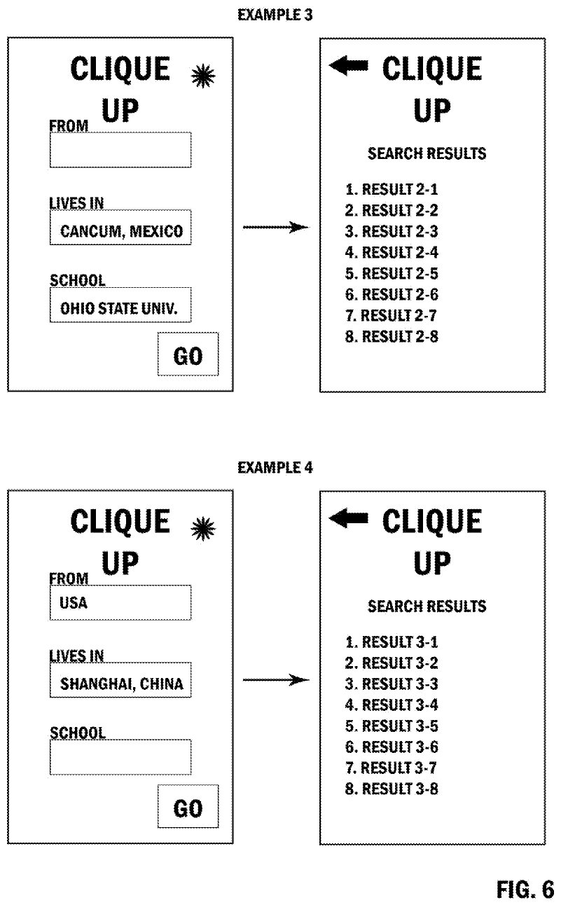

The illustrations of FIGS. 3-6 illustrate drawings of a prototypical user interface of a geolocating social networking system, as contemplated by the present disclosure. The drawings are meant to be exemplary only, and are not limiting for embodiments of the present system.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A geolocating social networking system, comprising:
a proprietary software;
a plurality of user accounts;
a plurality of user settings;
a social media interface;
a geolocating hardware;
a broadcasting subsystem;
a searching subsystem; and
a messaging subsystem;
wherein one each of said plurality of user accounts is correlated with one each of said plurality of user settings.

2. The invention of claim 1,
wherein said plurality of user settings include a username, a password, a profile picture, an age, a gender, a racial identity, a location, a point of origin, a religious preference, a political preference, a match preference, and a searchability.

3. The invention of claim 2,
wherein said plurality of user settings are selectable by a first user; and
wherein said plurality of user settings are selectable by a second user.

4. The invention of claim 3,
wherein said location and said point of origin are selectable by said first user; and
wherein said location and said point of origin are selectable by said second user.

5. The invention of claim 4,
wherein said searchability is reversibly activated by said first user; and
wherein said broadcasting subsystem of said first user broadcasts said match preference of said first user within a proximity of said location of said first user.

6. The invention of claim 5,
wherein said searching subsystem of said second user is reversibly activated by said second user;
wherein said searching subsystem of said second user searches said plurality of user accounts based on said plurality of user settings within a proximity of said location of said second user;
wherein said searching subsystem compares said match preference of said first user to said match preference of said second user to determine a match.

7. The invention of claim 6,
wherein said match of said match preference of said first user to said match preference of said second user notifies said first user and said second user of said match; and
wherein said match allows said messaging subsystem of said second user to communicate with said messaging subsystem of said first user.

8. The invention of claim 7,
wherein said social media interface automatically populates said username, said password, said profile picture, said age, and said gender.

9. The invention of claim 8,
wherein said geolocating hardware is a global positioning satellite receiver.

10. The invention of claim 9,
wherein said geolocating hardware automatically geolocates and selects said location of a user.

11. The invention of claim 10,
wherein said point of origin is selected from the group consisting of a locale, a city, a state, a country, a school, a college, and a university.

12. The invention of claim 11,
wherein said location is selected from the group consisting of a locale, a city, a state, a country, a school, a college, and a university.

13. The invention of claim 12,
wherein said proprietary software is a downloadable mobile application.

14. A method of using a geolocating social networking system, comprising:
downloading of said proprietary software by said first user;
establishing of one of said plurality of user accounts by said first user;
setting of said plurality of user settings by said first user;
activating said geolocating hardware by said first user to determine said location of said first user; and
activating said broadcasting subsystem of said first user to broadcast an availability of said first user within a proximity of said location of said first user.

15. The method of claim 14, further comprising:
downloading of said proprietary software by said second user;
establishing of one of said plurality of user accounts by said second user;
setting of said plurality of user settings by said second user;
activating said geolocating hardware by said second user to determine said location of said second user;
activating said searching subsystem of said second user to search said availability of said first user within a proximity of said location of said second user to determine a match; and
communicating via said messaging subsystem of said second user to said messaging subsystem of said first user after said match is determined.
